(19) United States
(12) Patent Application Publication
(10) Pub. No.: US 2022/0248685 A1
(43) Pub. Date: Aug. 11, 2022

(54) AGROCHEMICAL COMPOSITION COMPRISING PARTICLES OF SILICATE AND A FUNGICIDE

(71) Applicants: RHODIA OPERATIONS, Aubervilliers (FR); RHODIA BRASIL SA, Sao Paulo (BR)

(72) Inventors: Lidiane DE OLIVEIRA, Pinheiros - Valinhos (BR); Rogerio BARBOSA, São Paulo (BR); Jean-Christophe CASTAING, Sèvres (FR)

(21) Appl. No.: 17/617,400

(22) PCT Filed: Jun. 2, 2020
(86) PCT No.: PCT/EP2020/065140

§ 371 Date: Dec. 8, 2021

(30) Foreign Application Priority Data
Jun. 17, 2019 (EP) 19180489.7

(51) Int. Cl. A01N 63/22; A01N 25/06; A01N 25/12; A01N 43/54; A01N 43/56; A01N 43/653; A01N 59/16; A01P 3/00

(52) U.S. Cl. CPC A01N 63/22; A01N 25/06; A01N 25/12; A01P 3/00; A01N 43/56; A01N 43/653; A01N 59/16; A01N 43/54

(57) ABSTRACT

The present invention concerns an agrochemical composition comprising: —particles of at least one silicate; —one or more fungicide(s) selected from the group consisting of strobilurin fungicides, triazole fungicides, dithio-carbamate fungicides, succinate dehydrogenase inhibitors and biofungicides. The invention also concerns a method for treating a plant wherein a composition as described above is applied onto or next to at least one part of said plant.

The present invention concerns an agrochemical composition comprising particles of at least one silicate and at least one fungicide, advantageously in an aqueous liquid carrier.

Agrochemical compositions comprising mineral components such as silicates are already known in the prior art.

For example, patent application CN 102726613 A discloses a nutrient solution for plants under the form of an aqueous composition containing chitine as well as different mineral ingredients including tourmaline powder and magnetite powder.

Such a composition is used as seed dressing agent with the aim of increasing the germination rate and is further described as a fertilizer and growth promoter.

There is a continuous need for providing improved compositions for agriculture needs. Such compositions shall fulfill multiple different needs such as promote germination and plant growth, help increasing agriculture yields, and protect the plants against harmful parasites such as in particular fungi.

The inventors of the present application have now discovered that a composition comprising particles of silicate combined with antifungal agents chosen from particular families of fungicides advantageously in a liquid carrier exhibits excellent properties which make it particularly efficient when used in agrochemistry.

The present invention thus concerns an agrochemical composition comprising:
particles of at least one silicate;
one or more fungicide(s) selected from the group consisting of strobilurin fungicides, triazole fungicides, dithio-carbamate fungicides, succinate dehydrogenase inhibitors and biofungicides; and

Said composition advantageously further comprises an aqueous liquid carrier.

The present invention also concerns the use of such a composition for treating a plant, as well as a method for treating a plant wherein such a composition is applied onto or next to at least one part of said plant.

The composition of the present invention provides an agrochemical treatment of plants which leads to a faster germination of seeds, a faster plants growth, and in a general manner to improved yields.

Furthermore, the presence of the silicate particles in such a composition allows reducing the oxidative stress caused by the fungicide in the plant. The composition of the invention also helps reducing the phytotoxicity linked to the use of fungicides.

Other subjects, characteristics, aspects and advantages of the invention will emerge even more clearly on reading the description and the examples that follow.

In the present description, and unless otherwise indicated:
the expression “at least one” is equivalent to the expression “one or more” and can be replaced therewith;
the expression “between” is equivalent to the expression “ranging from” and can be replaced therewith and implies that the limits of the range are included;
the term “compound in CX” designates in a manner known per se a compound having X atoms of carbon in its molecule.

The composition of the present invention contains solid particles of one or more silicate(s).

The silicate is preferably selected from the group consisting of micas, aluminosilicates, tourmalines, serpentines and mixtures thereof.

The aluminosilicates can belong to clays or not.

Among the aluminosilicates, mention can be made of some groups such as feldspars, zeolites and kaolinites, and of specific aluminosilicates such as for example petalite, prehnite, delhayelite, bannisterite, allophane, crysocolla, minehillite, wickendurgite, franklinphilite.

Among the aluminosilicates from clay materials, besides the kaolinites, mention can be made of minerals from chlorite group, illite, glauconite, montmorillonite, palygorskite, pyrophyllite, sauconite and vermiculite.

According to a most preferred embodiment the silicate is selected from the group consisting of tourmalines.

The D90 size of the particles of silicate preferably ranges from 0.1 to 30 μm, preferably from 0.5 to 20 μm, more preferably from 1 to 15 μm, even more preferably from 2 to 10 μm and most preferably from 5 to 7 μm.

In a manner known per se in the field of particle size analysis, D90 designates the point in the volume size distribution of a population of particles, up to and including which, 90% of the total population is contained. In other words, D90 is defined by the value in the particle size distribution of a sample where 90% of the particles present in the sample are equal of below that value. For example, a sample of particles having a D90 of 1 μm means that 90% by volume of the sample has a size of 1 μm or smaller.

The size distribution of a sample of particles can be measured using the laser diffraction particle size analysis method (using, for example, Malvern or Cilas particle size analyzers). One advantageous way to carry out the process consists in suspending the particles in water and in determining their particle size by laser diffraction using the method described in standard ISO 13320:2009.

The particles of at least one silicate preferably represent from 0.15 to 10% by weight, more preferably from 0.20 to 8% by weight, more preferably from 0.25 to 5% by weight, and even more preferably from 0.50 to 2% by weight, with regard to the total weight of the composition.

The composition of the invention further contains one or more fungicide(s) chosen from the group consisting of strobilurin fungicides, triazole fungicides, dithio-carbamate fungicides, succinate dehydrogenase inhibitors, biofungicides, and mixtures thereof.

Among the strobilurin fungicides useful in the present invention, azoxystrobin and pyraclostrobin are especially preferred.

Among the triazole fungicides, prothioconazole and epoxiconazole are preferred.

Among the dithio-carbamate fungicides, mention can be made in particular of mancozeb.

The succinate dehydrogenase inhibitors useful in the present invention are especially chosen from pyrazole-carboxamide fungicides. Among the latter ones, fluxapyroxad, benzovindiflupyr and bixafen are preferred.

The biofungicides are bacteria having antifungal properties. Among them, mention sham be made in particular of Bacillus subtilis.

According to a preferred embodiment, said one or more fungicide(s) is chosen from the group consisting of strobilurin fungicides, triazole fungicides, succinate dehydrogenase inhibitors, and mixtures thereof, more preferably from pyrazole-carboxamide fungicides, even more preferably from fluxapyroxad, benzovindiflupyr, bixafen and mixtures thereof, and most preferably fluxapyroxad.

The composition of the invention preferably contains said one or more fungicide(s) in a total amount ranging from 0.1 to 50 g/L, preferably from 0.5 to 30 g/L, and more preferably from 1 to 10 g/L. These amounts are expressed in total weight of fungicide(s) per volume (L) of said composition.

According to a preferred embodiment, the ratio between the total amount by weight of particles of silicate in the composition on one hand and the total amount by weight of said fungicide(s) in the composition on the other hand ranges from 5 to 20, preferably from 6 to 10.

When used, the carrier of the composition of the invention is liquid at ambient temperature (25° C.) and atmospheric pressure (1,013·10⁵ Pa).

According to the invention, the composition is advantageously under the form of a suspension of said solid particles within the liquid carrier.

The composition of the invention may contain an aqueous liquid carrier that is to say the carrier contains water. The carrier can be made of water, or of water mixed with one or more organic fluid(s) which can be water-miscible or not.

When the carrier contains water and one or more water-immiscible organic fluid(s), said carrier may be in the form of an emulsion.

The organic fluids can be for example chosen from natural or synthetic oils, in particular mineral oils, vegetable oils, fatty or non fatty alcohols, fatty acids, esters containing at least one fatty acid and/or at least one fatty alcohol.

The fatty alcohols and fatty acids mentioned above are those which contain from 8 to 32, preferably from 10 to 26 and more preferentially from 12 to 22 carbon atoms.

The organic fluids when used are preferably water-miscible in any proportions. They can in particular be chosen from mono-alcohols containing from 2 to 5 carbon atoms, such as ethanol and isopropanol and from polyols such as, in particular, glycol, glycerol, saccharides such as sorbitol.

In a particularly preferred embodiment, an organic fluid that is advantageously a mineral oil or soya oil methyl ester is used, as an adjuvant for the fungicide(s) in the composition according to the invention.

It is of course possible to use mixtures of organic fluids and in particular any mixtures of any of the fluids described above.

According to one particularly preferred embodiment, the carrier of the composition used in the present invention is water.

The composition advantageously contains at least 20% by weight of water, more preferentially at least 30% by weight of water, more preferentially at least 40% by weight of water, and even more preferentially at least 50% by weight of water, relative to the total weight of said composition.

When one or more organic fluids are present, the composition preferably contains from 0.005% to 2% by weight of organic fluid(s), more preferentially from 0.01% to 1% by weight of organic fluid(s), relative to the total weight of said composition.

The composition of the present invention may further contain particles of one or more additional mineral compound(s).

The additional mineral compounds usable according to the invention can be chosen in particular from oxides, sulfates, carbonates, and phosphates.

The oxides can advantageously be chosen from titanium dioxide, silicon dioxide and magnesium oxide.

The sulfates are advantageously chosen from alkali metal and alkaline-earth metal sulfates, preferably from barium sulfate, calcium sulfate and strontium sulfate.

According to a particularly preferred embodiment of the invention, use is made of particles of barium sulfate.

The carbonates are advantageously chosen from calcium carbonate and sodium carbonate.

The phosphates can be chosen from zirconium phosphates, cerium phosphate and apatite, and mixtures thereof.

When they are present, said one or more additional mineral compound(s) are preferably used under the form of particles which are distinct from said particles of silicate. In this case, the D90 size of the particles of additional mineral compound(s) preferably ranges from 0.1 to 30 μm, preferably from 0.5 to 20 μm, more preferably from 1 to 15 μm, even more preferably from 2 to 10 μm and most preferably from 3 to 4 μm.

The particles of said one or more additional mineral compound(s) can represent from 0.05 to 2% by weight, more preferably from 0.1 to 1.5% by weight, even more preferably from 0.2 to 1% by weight, and most preferably from 0.5 to 1% by weight, with regard to the total weight of the composition.

The composition used in the present invention may further contain one or more surfactants.

These surfactants are preferably chosen from the group consisting of betaines, amine oxides, ethoxylated fatty amines, fatty amines, ether carboxylates, acid or non acid mono- and di-ester phosphates, optionally polyalkoxylated, alkylmonoglycosides, alkylpolyglycosides, and mixtures thereof.

The betaine surfactants are in particular those described in WO2006/069794. Preferably, the betaine surfactants are chosen from the betaines having formula R¹R²R²N⁺—CH₂COO⁻ (I), the betaines having formula R¹—CO—NH—R⁴R²R²N⁺—CH₂COO⁻ (II), and mixtures thereof, wherein the 10 group is a linear or branched hydrocarbon group, preferably an alkyl group containing 2 to 30 carbon atoms, preferably 2 to 24 carbon atoms, preferably 3 to 20 carbon atoms; the R² groups which are identical or different, are a C1-C3 alkyl group, preferably a methyl group, and the R⁴ group is a divalent linear or branched hydrocarbon group containing 1 to 6 carbon atoms, optionally substituted with a hydroxyl group, preferably a group of formula —CH₂—CH₂—CH₂— or —CH₂—CHOH—CH₂—.

Preferably, in formulae (I) and (II) above, R² is a methyl group. R¹ is preferably an alkyl group. This group is usually a mixture of different groups having different numbers of carbon atoms, being linear or branched, and optionally having some insaturations. These mixtures come from the reagents used to prepare them, which are actually distillation cuts and/or have a natural origin. In the present specification the number of carbon atoms in the R¹ group refers to the number of carbon atoms of the two most represented species.

The preferred betaine surfactants are those wherein R² is a methyl group, R¹ is a lauryl alkyl group mixture, preferably having more than 50% by weight of C12 and R⁴ if present is —CH₂—CH₂—CH₂—.

Betaines of formula (I) are preferred. They are often referred to as alkyl betaines, and are preferably an alkyldimethyl betaine based surfactant, for example lauryl dimethyl betaine based surfactant (R² is a methyl group and R¹ is a lauryl C12 group).

Betaines of formula (II) are often referred to as alkyl amidoalkyl betaines.

The amine oxide surfactants which may be used as surfactants in the present invention are in particular those described in WO2006/069794.

The amine oxides surfactants which may be used can be chosen from the amine oxides having formula R¹R²R²N→0 (III), the amine oxides having formula R¹—CO—NH—R⁴R²R²N→0 (IV), and mixtures thereof, wherein R¹, R² and R⁴ are as described in formulae (I) and (II) above.

In formulas (III) and (IV) above, the R² group is preferably a methyl group. R¹ is preferably an alkyl group. This group is usually a mixture of different groups having different numbers of carbon atoms, being linear or branched, and optionally having some insaturations. These mixtures come from the reagents used to prepare them, which are actually distillation cuts and/or have a natural origin. In the present specification the number of carbon atoms in the R¹ group refers to the number of carbon atoms of the two most represented species.

The preferred amine oxide surfactants are those wherein R² is a methyl group, R¹ is a lauryl alkyl group mixture, preferably having more than 50% by weight of C12 and R⁴ if present is —CH₂—CH₂—CH₂—. Amine oxides of formula (III) are preferred. They are often referred to as alkyl amine oxides, and are preferably an alkyldimethyl amine oxide based surfactant, for example lauryl dimethyl amine oxide based surfactant (R² is a methyl group and R¹ is a lauryl C12 group).

Amine oxides of formula (IV) are often referred to as alkyl amidoalkyl amine oxides.

The fatty amines or ethoxylated fatty amines useful as surfactants in the present invention may comprise at least one hydrocarbon group containing 2 to 24 carbon atoms, optionally polyalkoxylated.

The fatty amines or ethoxylated fatty amines may more particularly be selected from amines comprising at least one linear or branched, saturated or unsaturated group containing 2 to 24 carbon atoms, preferably 8 to 18 carbon atoms, optionally comprising 2 to 30 oxyethylene groups, or a mixture of a plurality thereof. Examples include ethoxylated tallow amines. The fatty amines or ethoxylated fatty amines may be selected from ethoxylated fatty amines comprising at least one or several, linear or branched, saturated or unsaturated, group(s) containing 6 to 24 carbon atoms, preferably 8 to 20 carbon atoms, comprising 2 to 30 oxyethylene groups, or mixtures thereof.

Examples include the compounds having the following formula (V):

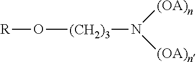

wherein R represents a linear or branched, saturated or unsaturated hydrocarbon group containing 6 to 24 carbon atoms, preferably 8 to 20 carbon atoms; OA represents an oxyalkylene group; and n, n′, which may or may not be identical, represent a mean number in the range 1 to 30.

Examples of such amines to be cited are amines derived from copra and containing 5 oxyethylene (OE) units, oleic amines containing 5 OE, amines derived from tallow containing 5 to 20 OE, for example 10 OE, compounds corresponding to the above formula in which R is an alkyl group containing 12 to 15 carbon atoms and the total number of OE units is in the range 20 to 30.

The ether carboxylates useful as surfactants in the present invention preferably have the following formula (VI): R(OCH₂CH₂)ₙOCH₂CO₂, wherein R is a linear or branched alkyl, alkenyl, alkylphenyl or polypropyleneoxy group having from 6 to 20, for example 8 to 14, aliphatic carbon atoms and n is a number ranging of from 1 to 30, preferably of from 2 to 20. The ether carboxylate has preferably a counter ion being ammonium or potassium, or obtained from an amine or alkanolamine having up to 6 carbon atoms.

The optionally polyalkoxylated acid or non acid mono- and di-ester phosphates useful as surfactants in the present invention are selected from acid or non acid phosphate mono- or di-esters, optionally polyalkoxylated, having the following formula (VII):

(A)₃₋ₘP(═O)(OM)ₘ

wherein:
A, identical or different, represents a group R′¹—O(CH₂—CHR′²—O)ₙ wherein:
   R′¹ represents a linear or non linear, saturated or unsaturated C6-C20 hydrocarbon group, preferably C8-C18;
   R′² represents a hydrogen atom or a methyl or ethyl group, preferably a hydrogen atom;
   n is a mean number of motifs in the range 0 to 10, preferably in the range 2 to 10;
M represents a hydrogen atom, an alkali or alkaline-earth metal, a N(R³)₄⁺ type radical wherein the R³ groups, identical or different, represents a hydrogen atom or a linear or non linear, saturated or unsaturated C1-C6 hydrocarbon group optionally substituted with a hydroxyl group;
m is a whole or average number in the range 1 to 2.

The acid or non acid mono- and di-ester phosphate, optionally polyalkoxylated may be in the form of a monoester, a diester, or a mixture of these two esters.

The preferred surfactants are chosen from anionic surfactants such as ether carboxylates, optionally polyalkoxylated acid or non acid mono- and di-ester phosphates, and mixtures thereof.

When the composition used in the present invention comprises one or more surfactants, the total amount of said surfactant(s) preferably ranges from 0.005 to 0.2% by weight based on the total weight of the composition.

According to a preferred embodiment, the composition of the present invention further contains one or more thickening agent(s).

Suitable thickening agent can be in particular chosen from polysaccharides such as for example xanthan gum, alginates, carboxylated or hydroxylated methylcelluloses, synthetic macromolecules of the polyacrylate, polymaleate, polyvinylpyrrolidone, polyethylene glycol or polyvinyl alcohol type.

When the composition comprises one or more thickening agents, the total amount of thickening agent(s) preferably ranges from 0.0005 to 0.05% by weigh, preferably from 0.001 to 0.02% by weight, based on the total weight of the composition.

According to a preferred embodiment, the composition of the present invention further contains one or more dispersant(s). Suitable dispersants include in particular polycarboxylate polymers such as sodium polycarboxylate.

When the composition comprises one or more dispersant(s), the total amount thereof preferably ranges from 0.0005 to 0.05%, preferably from 0.001 to 0.02% by weight, more preferably from 0.003 to 0.01% by weight, based on the total weight of the composition.

The composition according to the present invention may further contain one or more fertilizers, preferably chosen from water-soluble fertilizers such as for example foliar fertilizers (fertilizers which are taken up by the leaves of the plants), such as urea or foliar macro- or microelement fertilizer, including chelates.

The composition may further contain additional ingredients, which can be chosen from all additives and adjuvants useful in agrochemical compositions such as for example nutrients, anti-foaming agents, colorants such as pigments, etc.

According to a preferred embodiment, the composition of the present invention does not contain any xyloglucan polymer or oligomer.

All the amounts above are defined considering a ready-to-use composition, that is to say that the above composition according to the invention is preferably already in its diluted form for an application by spray onto or next to the crop, in particular onto the leaves of the plant, even if it can still be further diluted if necessary.

It can be considered for storage, transportation, or any other reason; to have a concentrated version of the composition of the invention and in this case all the above amounts (percentage by weight based on the total weight of the concentrated composition) would be multiplied by from 10 to 500, preferably by 50 to 200 and notably by around 100. In this embodiment, said concentrated composition would be diluted just before application. The dilution would thus be from 10 to 500, preferably by 50 to 200 and notably by around 100.

The composition according to the invention can be prepared by simple mixing of the ingredients, i.e
particles of at least one silicate;
one or more fungicide(s) selected from the group consisting of strobilurin fungicides, triazole fungicides, dithio-carbamate fungicides, succinate dehydrogenase inhibitors and biofungicides; and
an aqueous liquid carrier.

In a particularly preferred embodiment, to a defined volume of water (depending on the surface of crop to be treated), the one or more fungicide(s) list above is(are) added and optionally an organic fluid that is advantageously a mineral oil or soya oil methyl ester. Then the particles of the at least one silicate, preferably in the form of an aqueous suspension, are added.

The present invention also concerns a method for treating a plant wherein a composition as described above is applied onto or next to at least one part of said plant.

The composition described above can be either applied as such directly onto or next to the plant, or it can be diluted just before application for example with a liquid diluent comprising water or a mixture of water and organic solvent, or it can be mixed just before application with another agrochemical composition.

The method of the present invention can be implemented on any type of plant. The plants are preferably chosen among agricultural and horticultural plants, shrubs, trees and grasses.

The plant species include but are not limited to corn (Zea mays), Brassica sp. (e.g., B. napus, B. rapa, B. juncea), alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Cofea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), canola, oats, barley, vegetables, ornamentals, woody plants such as conifers and deciduous trees, squash, pumpkin, hemp, zucchini, apple, pear, quince, melon, plum, cherry, peach, nectarine, apricot, strawberry, grape, raspberry, blackberry, soybean, sorghum, sugarcane, rapeseed, clover, carrot, and Arabidopsis thaliana.

Further examples of plants include tomatoes (Lycopersicon esculentum), lettuce (e.g., Lactuca sativa), green beans (Phaseolus vulgaris), lima beans (Phaseolus limensis), peas (Lathyrus spp.), cauliflower, broccoli, turnip, radish, spinach, cabbage, asparagus, onion, garlic, pepper, celery, and members of the genus Cucumis such as cucumber (C. sativus), cantaloupe (C. cantalupensis), and musk melon (C. melo).

Mention can further be made of ornamentals species including but not limited to hydrangea (Macrophylla hydrangea), hibiscus (Hibiscus rosasanensis), petunias (Petunia hybrida), roses (Rosa spp.), azalea (Rhododendron spp.), tulips (Tulipa spp.), daffodils (Narcissus spp.), carnation (Dianthus caryophyllus), poinsettia (Euphorbia pulcherrima), and chrysanthemum; and of conifer species including but not limited to conifers pines such as loblolly pine (Pinus taeda), slash pine (Pinus elliotii), ponderosa pine (Pinus ponderosa), lodgepole pine (Pinus contorta), and Monterey pine (Pinus radiata), Douglas-fir (Pseudotsuga menziesii); Western hemlock (Tsuga canadensis); Sitka spruce (Picea glauca); redwood (Sequoia sempervirens); true first such as silver fir (Abies amabilis) and balsam fir (Abies balsamea); and cedars such as Western red cedar (Thuja plicata) and Alaska yellow-cedar (Chamaecyparis nootkatensis).

In one embodiment, the plant is chosen from leguminous plant species including but not limited beans and peas. Beans include guar, locust bean, fenugreek, soybean, garden beans, cowpea, mungbean, lima bean, fava bean, lentils, chickpea, green pea, moth bean, broad bean, kidney bean, lentil, dry bean, etc. Legumes include, but are not limited to, Arachis, e.g., peanuts, Vicia, e.g., crown vetch, hairy vetch, adzuki bean, mung bean, and chickpea, Lupinus, e.g., lupine, trifolium, Phaseolus, e.g., common bean and lima bean, Pisum, e.g., field bean, Melilotus, e.g., clover, Medicago, e.g., alfalfa, Lotus, e.g., trefoil, lens, e.g., lentil, and false indigo. Typical forage and turf grass for use in the methods described herein include but are not limited to alfalfa, orchard grass, tall fescue, perennial ryegrass, creeping bent grass, lucerne, birdsfoot trefoil, clover, stylosanthes species, lotononis bainessii, sainfoin and redtop. Other grass species include barley, wheat, oat, rye, orchard grass, guinea grass, sorghum or turf grass plant.

According to a preferred embodiment, the plant is selected from the group consisting of soy, cane, cotton, wheat, beans, rice, and preferably the plant is soy.

The composition of the invention can be applied on the plant at any stage of its development. It can be applied on the whole plant or on parts thereof.

According to a preferred embodiment, the composition is applied onto the foliar system of the plant. Such application is preferably carried out by spraying a composition as disclosed above onto the leaves of the plant. For example, the composition can be sprayed onto a field using appropriate means well known in agriculture.

In a general manner, the composition of the invention can be easily applied onto or next to plants or parts thereof using any conventional and commercially available application equipment.

The invention also concerns the use of an agrochemical composition as disclosed above for treating a plant.

The above description of the method of the invention also applies to the use according to the invention.

The examples of implementation of the invention below are given purely by way of illustration and shall not be interpreted at limiting the scope thereof.

### EXAMPLES

### Example 1

The experiments described below were done in the city of Rolandia, Parana state in Brazil, wherein the predominant climate is temperate (mesothermic) with rains in the summer and drought in the winter (Cwa—Koeppen).

The mineral used in the below described experiment is a powder of black tourmaline from Micro Service—Tecnologica em Micronização, Produtos e Processos Industriais, having a granulometry D90=6 μm.

The particle size distribution was measured by using the Malvern Mastersizer 2000 particle size analyzer, with the following parameters:
Material: tourmaline (RI=1.62)
Dispersant media: water
Pumping: 1250 rpm
Mixing: 500 rpm
Ultrasound: 20%
Obscuration: 10-20%.

The following compounds have been used:
Lamegal HS/B=Aqueous solution of sodium polycarboxylate Mw=2000 g/mol at a concentration of 40 to 42% by weight, from the company Lamberti;
Geropon T 36=Aqueous solution of sodium polycarboxylate at a concentration of 90% by weight, from the company Solvay;
Proxel GXL=Aqueous solution of 1,2-benzisothiazolin-3-one (antifungal agent) from the company Lonza;
Rhodopol 23=Aqueous solution of xantan gum at a concentration of 2% by weight from the company Solvay.

An aqueous suspension of mineral particles (hereafter referred to as Suspension G2g) was prepared, using the following protocol: Lamegal HS/B, Geropon T36 and Proxel GXL were added in water and mixed until homogeneous solution. Then, the mineral particles were added and mixed until homogeneous dispersion. Finally, Rhodopol 23 was added and mixed until homogeneous formula. The mechanical agitator used was a IKA RW20 model with naval propeller stirrer.

The composition of Suspension G2g is detailed in Table 1 below, where all amounts are expressed as percentages by weight of raw material (and not as active matter for the commercial products).

TABLE 1
Suspension G2g - 60% by weight of active particles:

| | Amount |
|---|---|
| Component | (% by weight) |
| G2g particles (tourmaline D90 = 6 μm) | 60.00 |
| Lamegal HS/B | 0.05 |
| Geropon T36 | 0.65 |
| Proxel GXL | 0.50 |
| Rhodopol 23 | 6.50 |
| Demineralized water | 32.30 |

An inventive composition C2 was prepared by mixing (amounts expressed in L/ha):
0.8 L/ha of a fungicide composition containing 81 g/L of pyraclostrobin, 50 g/L of epoxiconazole and 50 g/L of fluxapyroxad (sold by the company BASF under the name Ativum);
0.5 L/ha of mineral oil (adjuvant for the fungicide—sold by the company BASF under the name Assist);
1.3 L/ha of G2g Suspension described above—in 1.3 L of G2g suspension we have 1.3 kg of mineral particles (d=1.678 kg/L)
100 L/ha of water.

A comparative composition C3 was prepared by mixing (amounts expressed in L/ha):
0.8 L/ha of the fungicide composition containing 81 g/L of pyraclostrobin, 50 g/L of epoxiconazole and 50 g/L of fluxapyroxad (sold by the company BASF under the name Ativum);
0.5 L/ha of mineral oil (adjuvant for the fungicide—sold by the company BASF under the name Assist);
100 L/ha of water.

A comparative composition C4 was prepared by mixing (amounts expressed in L/ha):
1.3 L/ha of G2g Suspension described above—in 1.3 L of G2g suspension we have 1.3 kg of mineral particles (d=1.678 kg/L)
100 L/ha of water.

The three compositions C2, C3 and C4 were sprayed onto leaves of soy following the treatment schemes detailed in Table 2 below.

TABLE 2
treatment schemes for foliar application

| | | Dose of composition |
|---|---|---|
| Treatment | Composition | applied expressed in l/ha |
| T1 (blank) | None | — |
| T2 (invention) | C2 | 0.8 Ativum + 0.5 Assist + |
| | | 1.3 Suspension G2g |
| T3 (comparative) | C3 | 0.8 Ativum + 0.5 Assist |
| T4 (comparative) | C4 | 1.3 Suspension G2g |

The different treatments were applied when plants were in the growth stage (flowering), 3 times within a period of 60 days.

The overall yield (expressed in bags of 60 kg each) was determined 110 days after planting.

The results obtained are detailed in Table 3 below.

TABLE 3
Results of foliar application tests

| | Yield | Increase in Yield |
|---|---|---|
| Treatment | (bags/ha) | compared to blank (%) |
| T1 (blank) | 40.8 | — |
| T2 (invention) | 61.4 | 50.5% |
| T3 (comparative) | 57.1 | 40.0% |
| T4 (comparative) | 41.9 | 2.7% |

The above results show that the application of inventive composition C2 onto the leaves of the plant has a synergistic positive effect on the yield compared to comparatives T3 and T4. A possible explanation is that the presence of the particles of tourmaline in the composition reduces the oxidative stress caused by the fungicide in the plant, resulting in an increase of the yield.

### Example 2

The experiments described below were done in the city of Botucatu, Sao Paulo state in Brazil, wherein the predominant climate is temperate (mesothermic) with rains in the summer and drought in the winter (Cwa—Köeppen), with average annual temperature of 20.5° C. and annual pluviometric precipitation of 1.533 mm.

Tests were done in green house with the following characteristics: 30 m of length, 7 m of width and 3 m height, covered with polyethylene film of low density and closed in the laterals with shading in 75% of the total area.

The same material and the same method to measure the particle size distribution as in example 1 are used in this example.

An aqueous suspension Suspension G2g is prepared as in Example 1 and table 1.

An inventive composition C′4 was prepared by mixing (amounts expressed in L/ha):
0.8 L/ha of a fungicide composition containing 81 g/L of pyraclostrobin, 50 g/L of epoxiconazole and 50 g/L of fluxapyroxad (sold by the company BASF under the name Ativum);
0.25 L/ha of mineral oil (adjuvant for the fungicide—sold by the company BASF under the name Assist);
1.3 L/ha of G2g Suspension described above—in 1.3 L of G2g suspension we have 1.3 kg of mineral particles (d=1.678 kg/L)
100 L/ha of water.

Another inventive composition C′6 was prepared by mixing (amounts expressed in L/ha):
0.4 L/ha of a fungicide composition containing 150 g/L of trifloxystrobin, 175 g/L of protioconazole (sold by the company BASF under the name FOX);
0.25 L/ha of a composition based on methylic ester of soy oil (adjuvant for the fungicide—sold by the company BASF under the name AUREO);
1.3 L/ha of G2g Suspension described above—in 1.3 L of G2g suspension we have 1.3 kg of mineral particles (d=1.678 kg/L)
100 L/ha of water.

A comparative composition C′3 was prepared by mixing (amounts expressed in L/ha):
0.8 L/ha of the fungicide composition containing 81 g/L of pyraclostrobin, 50 g/L of epoxiconazole and 50 g/L of fluxapyroxad (sold by the company BASF under the name Ativum);
0.25 L/ha of mineral oil (adjuvant for the fungicide—sold by the company BASF under the name Assist);
100 L/ha of water.

Another comparative composition C′5 was prepared by mixing (amounts expressed in L/ha):
0.4 L/ha of a fungicide composition containing 150 g/L of trifloxystrobin, 175 g/L of protioconazole (sold by the company BASF under the name FOX);
0.25 L/ha of a composition based on methylic ester of soy oil (adjuvant for the fungicide—sold by the company BASF under the name AUREO);
100 L/ha of water.

A last comparative composition C′2 was prepared by mixing (amounts expressed in L/ha):
1.3 L/ha of G2g Suspension described above—in 1.3 L of G2g suspension we have 1.3 kg of mineral particles (d=1.678 kg/L)
100 L/ha of water.

The five compositions C′2, C′3, C′4, C′5 and C′6 were sprayed onto leaves of soy following the treatment schemes detailed in Table 5 below.

TABLE 5
treatment schemes for foliar application

| | | Dose of composition |
|---|---|---|
| | | applied expressed in |
| Treatment | Composition | liter per hectare |
| T′1 (blank) | None | — |
| T′2 (comparative) | C′2 | 1.3 G2g |
| T′3 (comparative) | C′3 | 0.8 Ativum + 0.25 Assist |
| T′4 (invention) | C′4 | 0.8 Ativum + 0.25 |
| | | Assist + 1.3 G2g |
| T′5 (comparative) | C′5 | 0.4 FOX + 0.25 Aureo |
| T′6 (invention) | C′6 | 0.4 FOX + 0.25 |
| | | Aureo + 1.3 G2g |

Each treatment by each composition as shown in table 5 has been replicated 6 times. Each replicate was composed of 1 planter, with 5 plants.

Planters of 35 liters were used, with 44.5 cm height and 36.6 cm of diameter, with sandy soil. No additional fertilizer nor nutrients were added in the soil. The collected soil was collected from the soil layer classified as distroferric red latosol.

The seeds were added in the planters in 5 furrows containing 3 seeds each, and after 10 days the thinning was performed, leaving only 1 plant per furrow.

The different treatments were applied three times each: when plants were in the growth stage V8 (eighth node), then 20 days and 40 days after the first application. The application was done by using a manual cone nozzle spray with pressurized CO₂, at 0.3 kef/cm².

Two different conditions have been tested: without hydric stress (Experiment 1) and with hydric stress (Experiment 2). For Experiment 2, the hydric stress was created by watering the plants every 2 days and measured by using a Piché Evaporimeter, and the hydric stress caused corresponded to 50% of evapotranspiration. For Experiment 1, plants were watered every day.

The total protein and antioxidant activity of the plants were determined using the protocol detailed hereunder.

The collection of leaves was accomplished at 5, 10 and 15 days after the first application, being collected 4 leaves of each treatment, which were selected and standardized with the limbo totally expanded. These leaves were put in plastic bags that were covered by aluminum foil and immediately frozen in liquid nitrogen to stop any ongoing reaction. After, bags were stored in an ultra freezer at −80° C.

The quantification of total protein in the enzymatic extract was accomplished according to the methodology proposed by BRADFORD (1976). The reaction system was composed of 100 μL of enzymatic extract and 5000 μL of Bradford protein reagent. The reaction was done at 31° C. during 15 minutes and the absorbance measured at 595 nm in a spectrophotometer NI-2000 UV Vis, from Novainstruments. A casein solution was used as standard, and the weight of protein was plotted against the corresponding absorbance resulting in a standard curve used to determine the protein in unknown samples.

The activity of the catalase (CAT, EC 1.11.1.6 (CAT=catalase and EC=Enzyme Commission number: each enzyme has a different number, and this one is the reference for catalase)) was measured based on the methodology proposed by KAR and MISHRA in KAR, M.; MISHRA, D. Catalase, Peroxidase, and Polyphenoloxidase Activities during Rice Leaf Senescence. Plant Physiology, v. 57, p. 315-319, 1976 (KAR and MISHRA 1976), with some minor changes as described below.

Extractor solution: 17.41 g of K₂HPO₄ (dibasic) is added in 1000 ml of distilled water (solution A), while 6.8 g of KH₂PO₄ (monobasic) is added in 500 ml of distilled water (solution B). Both solutions are homogenized, separately. Then, the monobasic solution is added into the dibasic solution until reaching pH 7.8 in order to prepare the solution C. After, 0.372 g of ethylenediaminetetraacetic acid (EDTA), 0.462 g of DL-dithiothreitol (DTT) and 0.300 g of polyvinylpolypyrrolidone (PVPP) are added in 1000 ml of solution C.

Determination solution: 17.41 g of K₂HPO₄ (dibasic) is added in 1000 ml of distilled water (solution A), while 6.8 g of KH₂PO₄ (monobasic) is added in 500 ml of distilled water (solution B). Both solutions are homogenized, separately. Then, the monobasic solution is added into the dibasic solution until reaching pH 7.5 in order to prepare the determination solution.

Enzymatic extract: It was used 0.1 g of frozen fresh leaves, which were grinded in liquid nitrogen. Then, it was added 3 mL of a solution called extractor solution. Sample is homogenized and centrifuged at 10000×g (the gravitational force in Earth) for 25 minutes at 4° C. The supernatant obtained from this process is called enzymatic extract.

Catalase activity determination: In a quartz cuvette it was added 1950 μL of determination solution, 150 μL of extraction solution, 750 μL of H₂O₂ (50 mM) and 150 μL of enzymatic extraction. In parallel, a blank was prepared by combining 1950 μL of determination solution, 300 μL of extraction solution and 750 μL of H₂O₂ (50 mM). The absorbance at 240 nm was measured in a spectrophotometer NI-2000 UV Vis, from Novainstruments, at 0 and at 80 seconds, aiming at verifying the absorbance decrease (when the absorbance of the sample reaches the same absorbance as the blank), which happened at 80 seconds in the present assay. The unit of catalase activity used was the amount of enzyme which breaks down 1 μmol of H₂O₂/min under the assay conditions described, and it was calculated as follows:

Catalase activity (μmol of H₂O₂ min⁻¹ mg⁻¹ of protein)=[(absorbance at 0 seconds−absorbance at 80 seconds)×A×B]/(C×D×E×F)

Where:

A=cuvette path length (in cm)

B=volume of enzymatic extraction (in μL)

C=weight of frozen fresh leaves (in mg)

D=volume of solution after centrifugation (in μL)

E=final time considered for absorbance reading (in minutes)

F=molar coefficient of H₂O₂ at 240 nm (39.4 μM⁻¹ cm⁻¹)

The results of Experiment 1′ (no hydric stress) and Experiment 2′ (hydric stress) are respectively detailed in Table 6 and 7 below, which indicates the total protein results obtained for samples from three different collection times (5, 10 and 15 days after application).

TABLE 6
Results of Experiment 1 (foliar application, no hydric stress)

| | % increase of total protein - |
|---|---|
| Treatment | 10 days after application |
| T1′ (blank) | 0 |
| T′2 comparative, G2g) | 25 |
| T′3 (comparative, Ativum + Assist) | 11 |
| T′4 (invention, Ativum + Assist + G2g) | 18 |
| T′5 (comparative, FOX + Aureo) | 2 |
| T′6 (invention, FOX + Aureo + G2g) | 7 |

TABLE 7
Results of Experiment 2 (foliar application, hydric stress)

| | % increase of total protein - |
|---|---|
| Treatment | 15 days after application |
| T′1 (blank) | 0 |
| T′2 (comparative, G2g) | 5 |
| T′3 (comparative, Ativum + Assist) | 1 |
| T′4 (invention, Ativum + Assist + G2g) | 6 |
| T′5 (comparative, FOX + Aureo) | −4 |
| T′6 (invention, FOX + Aureo + G2g) | 6 |

The above results show that the application of particles of tourmaline onto the leaves allow achieving an important increase of the quantity of total protein of the soy plant. However, the use of fungicides is creating phytotoxicity, which affects the increase of total proteins (see comparative T′3 and T′5). Moreover, the results show that the application of particles of tourmaline in combination with commercial fungicides (T′4 and T′6) onto the leaves reduces the phytotoxicity effect of the fungicides, reducing the loss of total protein observed when the fungicides are applied (T′3 and T′5).

The activity of the antioxidant enzyme catalase of Experiment 1 (no hydric stress) and Experiment 2 (hydric stress) are respectively detailed in Table 8 and 9 below, which indicates the average of results obtained for samples collected at 5 days after application

TABLE 8
Results of Experiment 1 (foliar application, no hydric stress)

| | % increase of activity of the |
|---|---|
| | antioxidant enzyme catalase - |
| Treatment | 5 days after application |
| T′1 (blank) | 0 |
| T′2 (comparative, G2g) | 96 |
| T′3 (comparative, Ativum + Assist) | 103 |
| T′4 (invention, Ativum + Assist + G2g) | 199 |
| T′5 (comparative, FOX + Aureo) | −7 |
| T′6 (invention, FOX + Aureo + G2g) | 23 |

TABLE 9
Results of Experiment 2 (foliar application, hydric stress)

| | % increase of activity of the |
|---|---|
| | antioxidant enzyme catalase - |
| Treatment | 5 days after application |
| T′1 (blank) | 0 |
| T′2 (comparative, G2g) | 139 |
| T′3 (comparative, Ativum + Assist) | 119 |
| T′4 (invention, Ativum + Assist + G2g) | 294 |
| T′5 (comparative, FOX + Aureo) | 80 |
| T′6 (invention, FOX + Aureo + G2g) | 81 |

The above results show that the application of particles of tourmaline in combination with commercial fungicides (T′4 and T′6) onto the leaves allow achieving an increase in the activity of the antioxidant enzyme catalase, showing the capacity of the mineral in helping the plant dealing with the phytotoxicity effect of the fungicides.

The qualitative results of the yield obtained are detailed in Table 10 below.

TABLE 10
Qualitative results of foliar application tests.

| | Increase in Yield | Increase in Yield |
|---|---|---|
| | compared to | compared to |
| | blank (%) - no | blank (%) - with |
| Treatment | hydric stress | hydric stress |
| T′1 (blank) | 0 | 0 |
| T′2 (comparative, G2g) | ++ | + |
| T′3 (comparative, Ativum + Assist) | + | − |
| T′4 (invention, Ativum + Assist + | ++++ | + |
| G2g) | | |
| T′5 (comparative, FOX + Aureo) | + | + |
| T′6 (invention, FOX + Aureo + | ++++ | + |
| G2g) | | |

The above results show that the application of the inventive composition onto the leaves of the plant has a positive effect on the yield compared to comparative T′2, as well as a positive effect reducing the phytotoxicity caused by the fungicides (T′4 and T′6 versus T′3 and T′5, respectively).

1. An agrochemical composition comprising:
particles of at least one silicate; and
one or more fungicide(s) selected from the group consisting of strobilurin fungicides, triazole fungicides, dithio-carbamate fungicides, succinate dehydrogenase inhibitors and biofungicides.

2. The composition of claim 1, further comprising an aqueous liquid carrier.

3. The composition of claim 1, wherein the silicate is selected from the group consisting of micas, aluminosilicates, tourmalines, serpentines and mixtures thereof.

4. The composition of claim 1, wherein the D90 size of the particles of silicate ranges from 0.1 to 30 μm.

5. The composition of claim 2, wherein the particles of at least one silicate represent from 0.15 to 10% by weight, with regard to the total weight of the composition.

6. The composition of claim 1, wherein said one or more fungicide(s) is selected from the group consisting of azoxystrobin, pyraclostrobin, prothioconazole, epoxiconazole, mancozeb, pyrazole-carboxamides, Bacillus subtilis, and mixtures thereof.

7. The composition of claim 1, wherein said one or more fungicide(s) is selected from the group consisting of strobilurin fungicides, triazole fungicides, succinate dehydrogenase inhibitors, and mixtures thereof.

8. The composition of claim 2, containing said one or more fungicide(s) in a total amount ranging from 0.1 to 50 g/L.

9. The composition of claim 2, wherein the aqueous carrier is water or water mixed with one or more organic fluid(s).

10. The composition of claim 2, containing at least 20% by weight of water, relative to the total weight of the composition.

11. The composition of claim 1, further containing one or more dispersant(s).

12. The composition of claim 11, wherein the amount of said one or more dispersant(s) ranges from 0.0005 to 0.05%, based on the total weight of the composition.

13. A method for treating a plant, the method comprising applying the composition of claim 1 onto or next to at least one part of said plant.

14. The method of claim 13 wherein the composition is applied directly onto or next to the plant, or is diluted just before application with a liquid diluent comprising water or a mixture of water and organic solvent, or is mixed just before application with another agrochemical composition.

15. The method of claim 13, wherein the composition is applied onto the foliar system of the plant.

16. The composition of claim 3, wherein the silicate is selected from the group consisting of tourmalines.

17. The composition of claim 7, wherein said one or more fungicide(s) is selected from the group consisting of pyrazole-carboxamide fungicides.

18. The composition of claim 17, wherein said one or more fungicide(s) is selected from the group consisting of fluxapyroxad, benzovindiflupyr, bixafen, and mixtures thereof.

19. The composition of claim 11, wherein the one or more dispersant(s) is selected from the group consisting of polycarboxylate polymers.

20. The method of claim 15, wherein the composition is applied by spraying said composition onto the leaves of the plant.
